(19) United States
(12) Patent Application Publication
(10) Pub. No.: US 2016/0318246 A1
(43) Pub. Date: Nov. 3, 2016

(54) ELECTROMAGNETIC BLUNTING OF DEFECTS WITHIN FUSED DEPOSITION MODELING (FDM)COMPONENTS

(71) Applicants: Orlando Rios, Knoxville, TN (US); Vlastimil Kunc, Concord, TN (US); Chad Duty, Loudon, TN (US); Lonnie Love, Knoxville, TN (US)

(72) Inventors: Orlando Rios, Knoxville, TN (US); Vlastimil Kunc, Concord, TN (US); Chad Duty, Loudon, TN (US); Lonnie Love, Knoxville, TN (US)

(21) Appl. No.: 14/699,426

(22) Filed: Apr. 29, 2015

(51) Int. Cl. B29C 67/00

(52) U.S. Cl. CPC B29C 67/007; B29C 67/0085; B33Y 10/00

(57) ABSTRACT

A method and apparatus for additive manufacturing that applies a magnetic field to reduce undesirable imperfections, such as voids or air pockets, in a deposited working material. The apparatus includes a nozzle for extruding a plastic material and a supply of polymeric working material provided to the nozzle, wherein the polymeric working material is magnetically susceptible and/or electrically conductive, and a magneto-dynamic heater for producing a time varying, high flux, frequency sweeping, alternating magnetic field in the vicinity of the nozzle and/or the deposited working material to penetrate into working material to reflow or constrict at least portions of the material through at least one of an induced transient magnetic domain and an induced, annular current.

### GOVERNMENT RIGHTS

This invention was made with government support under Contract No. DE-AC05-00OR22725 awarded by the U.S. Department of Energy. The government has certain rights in the invention.

### FIELD OF THE INVENTION

The present invention relates to post-deposition improvement and/or strengthening of components made through additive manufacturing by application of an electromagnetic field.

### BACKGROUND OF THE INVENTION

Additive manufacturing may be used to quickly and efficiently manufacture complex three-dimensional components layer-by-layer, effectively forming the component from the bottom up or the top down. Such additive manufacturing may be accomplished using polymers, alloys, powders, or similar feed materials that transition from a liquid or granular state to a cured, solid component.

Polymer-based additive manufacturing is presently accomplished by several technologies that rely on feeding polymer materials through a nozzle that is precisely located over a preheated polymer substrate. Parts are manufactured by the deposition of new layers of materials above the previously deposited layers. Unlike rapid prototyping processes, additive manufacturing is intended to produce a functional component constructed with materials that have strength and properties relevant to engineering applications. On the contrary, rapid prototyping processes typically produce exemplary models that are not production ready.

Heating of the feed or filler material in the nozzle in additive manufacturing is generally accomplished by direct contact between a polymer feed stock and a heating element, typically a metal cylinder at elevated temperatures. Likewise, in additive manufacturing, unlike rapid prototyping, the entire component under construction is typically maintained at an elevated temperature in a chamber or furnace until the build is complete. Keeping previously deposited layers at elevated temperature improves the adhesion between the component and newly deposited material while minimizing macroscopic distortion. There are inherent limitations to this technology that prevent higher deposition rates, out of furnace printing and control of microstructural defects (such as pores).

Magneto-thermal conversion is the conversion of electromagnetic energy into thermal energy. In ferromagnetic magnetic materials, a principle mechanism underlying magneto-thermal conversion is related to externally induced disturbances in the magnetic structure and how strongly the materials resist these disturbances. The dissipated electromagnetic energy is the product of these two and can be transformed into thermal energy among other forms. Therefore the external field should be sufficient to induce disturbances in the magnetic structure while the magnetic material should provide sufficient resistance to dissipate energy yet not resist so strongly that the external fields cannot induce disturbances. It is therefore desired to match the magnetic response of a material with the correct amplitude and frequency of electromagnetic energy. In soft magnetic materials, there is a minimal energetic barrier to either rotate the moment within a domain, or nucleate a reversed domain and move the resulting domain as opposed to hard magnetic materials that resist such disturbances. The energy product associated with magnetic materials is a function of the coercivity, remnant magnetization and magnetic anisotropy. In general, materials with coercivity ≧1000 Oe can be classified as hard ferromagnets. Soft ferromagnets have lower coercivity, and good soft ferromagnets have coercivity <1 Oe. Intermediate materials having a coercivity >1 Oe and <1000 Oe are useful in applications where a magnetic hysteresis losses are required in applications such as, for example, transformation of electromagnetic energy into thermal energy, also known as magneto-thermal conversion

### SUMMARY OF THE INVENTION

The present invention is generally directed to a non-contact improvement technology that can be used to strengthen deposited additive manufacturing components, such as by improving cohesion between deposition beads and/or reducing voids or defects. Embodiments of this invention provide methods of additive manufacturing comprising the steps of heating a polymeric working material to a flow consistency suitable for deposit, and then depositing the polymeric working material in multiple beads and/or layers to form a deposited working material. Upon deposition, at least one of targeted heat or a targeted magnetic field is applied to the deposited working material to improve the structural integrity, such as by reducing voids or air pockets in the deposited working material. The post-extrusion or post-deposition processes of this invention can be applied to one or more material beads, or to a partially or fully produced component.

Materials processed by additive manufacturing, including extrusion deposition such as fused deposition modeling (FDM), generally contain voids and air pockets that can be detrimental to final mechanical properties. These voids can also have sharp stress concentrators, such as at material bead contact areas between two abutting beads, due to the deposited material bead geometry. Electro-magnetic constriction according to this invention can be used to reduce or remove these voids during material deposition and/or after an intended component is produced. Electro-magnetic processing can additionally or alternatively be used to reflow only a surface of the deposited material bead, thereby blunting sharp features of the connections between adjacent beads without changing the overall geometry of the intended component.

This technology can be accomplished by applying high intensity electromagnetic energy, for instance, transient high flux alternating magnetic fields, to the polymer materials. Further, the polymer feed materials may be tuned by doping the polymer feed stock with specific magnetically active materials, microscale particles, and/or nano particles.

The magnetically susceptible or electrically conductive deposited working material is processed with a magnetic field produced in a vicinity of the deposited working material. In embodiments of this invention, a time varying magnetic field penetrates into and is coupled by the magnetically susceptible working material to induce transient magnetic domains, resulting in constriction or compaction of the deposited working material. In other embodiments of this invention a transient magnetic field penetrates into and is coupled by the electrically conductive working material to generate an induced, annular current that causes direct electrical resistive heating and reflow of the deposited working material. As a result, custom feed materials may be employed, depending on the desired characteristics of the build.

The invention further includes an apparatus for additive manufacturing that includes a nozzle for extruding a plastic material that is at least one of magnetically susceptible or electrically conductive, a deposition surface disposed beneath the nozzle, and a magneto-dynamic heater that produces a magnetic field at, such as over, under, or to the side of, the deposition surface. The magnetic field penetrates into the working material to heat the material through at least one of the induced transient magnetic domain or the induced, annular current. The magneto-dynamic heater desirably provides an adjustable electromagnetic field for creating various time varying, high flux, frequency sweeping, alternating magnetic fields.

Other objects and advantages will be apparent to those skilled in the art from the following detailed description taken in conjunction with the appended claims and drawings.

### BRIEF DESCRIPTION OF THE DRAWINGS

FIG. 1 is a schematic of a system according to one embodiment of this invention.

FIG. 2 is a side view of an exemplary nozzle for use in extrusion deposition according to embodiments of this invention.

FIG. 3 is a schematic of an exemplary nozzle and heater for use in extrusion deposition according to embodiments of this invention.

FIG. 4 is a schematic representation of an induced circular current resulting in an opposing magnetic field as generated by the system according to one embodiment of this invention.

FIG. 5 is a schematic representation of an extruded material bead according to embodiments of this invention.

FIG. 6 is a schematic representation of the material bead of FIG. 5 after processing according to embodiments of this invention.

FIG. 7 is a schematic representation of deposited layers of extruded material beads according to embodiments of this invention.

FIG. 8 is a schematic representation of the material beads of FIG. 7 after processing according to embodiments of this invention

### DETAILED DESCRIPTION OF THE INVENTION

The present invention includes a method and apparatus for improving structural integrity of deposited working material in additive manufacturing, such as by constricting material beads, improving cohesion between deposition beads, and/or reducing voids, air pockets, or other defects, and thereby strengthening the final production part.

The method of this invention includes heating via a conventional method or via application of electro-magnetic field in one or more areas where constriction, cohesion, and/or void removal is desired. To apply the electro-magnetic heating and/or constriction to the identified area, a time varying electro-magnetic field is applied, which induces current in the material opposing the build-up (change) of the primary magnetic field. This current generates induced magnetic field, which is opposite of the applied magnetic field. These opposing magnetic fields generate forces within the material, which can be used to compact an area within the extrusion deposition part in a controlled manner, thereby eliminating voids detrimental to parts performance. Application of the methods of this invention can be at the extrusion deposition printing head and/or via separate mechanism.

According to a preferred embodiment, the subject method and apparatus employs high intensity electromagnetic energy, for instance, transient high flux alternating magnetic fields, with deposited polymer materials, resulting in a highly controllable additive manufacturing process.

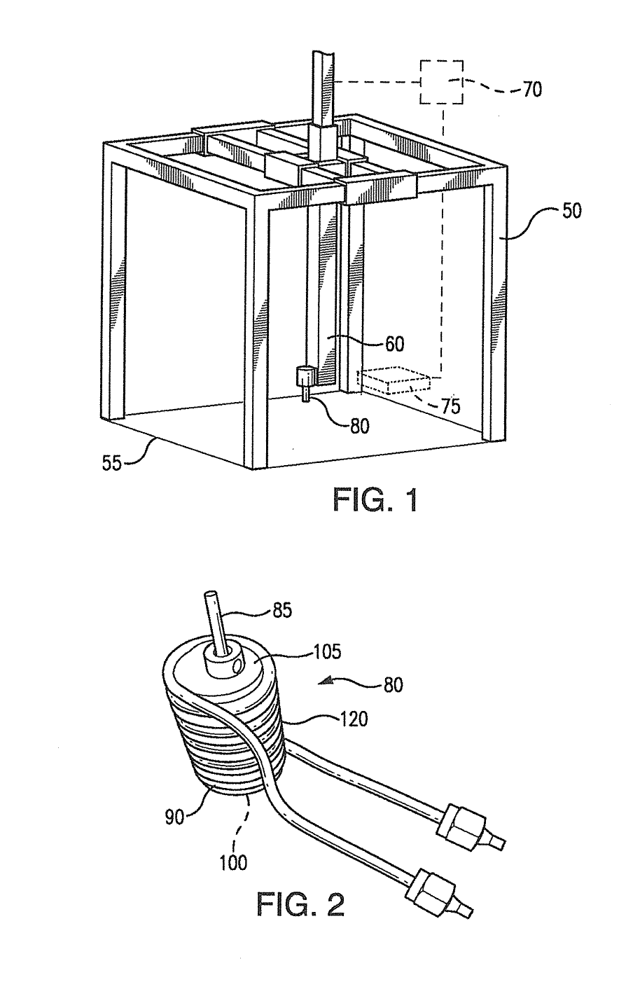

Although not required, the subject invention may be used in connection with large scale polymer added manufacturing such as the schematic shown in FIG. 1. FIG. 1 shows a frame or gantry 50 for containing a build. The gantry 50 preferably contains a deposition arm 60 that is moveable through the x, y and z-axis over a deposition surface 55. The deposition arm 60 preferably accommodates a supply of working material and a deposition nozzle 80. The supply of working material may be onboard the deposition arm and/or remotely supplied from a hopper or similar storage vessel.

According to preferred embodiments of the invention, a method of additive manufacturing includes the steps of providing an apparatus for additive manufacturing, for instance the gantry system shown in FIG. 1. The apparatus preferably includes a nozzle 80 over the deposition surface 55, and for extruding a material, such as shown in FIG. 2. The nozzle 80 preferably operably contacts a polymeric working material, preferably a material that is magnetically susceptible and/or electrically conductive for use in initial extrusion and/or post-extrusion processing according to this invention. FIG. 2 shows an exemplary embodiment of the nozzle 80 including a barrel 85 through which the working material is provided, a plate 90 and a tip 100 from which the working material is directly deposited on the build. A coil 120 is preferably wrapped around the barrel and comprises an assembly that may further include a thermally conductive wrap 105 around the barrel 85 for instance, boron nitride.

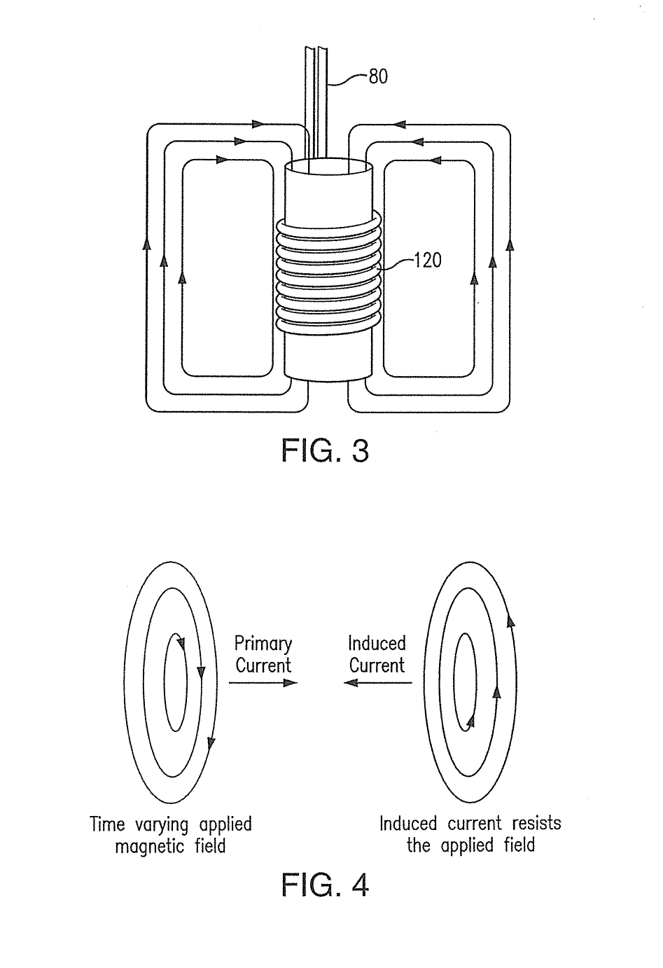

A schematic of a deposition nozzle 80 used in such a system is shown in FIG. 3. As shown in FIGS. 3 and 4, rapidly changing magnetic fields transfer energy to the working material matrix by two interrelated mechanisms. Transient magnetic fields penetrate into and are coupled by the magnetic properties of the matrix materials. This leads to an induced circular current that result in the generation of an opposing magnetic field as shown in FIG. 4. The induced current leads to direct electrical resistive heating of the material. Additionally, the external fields lead to generation of magnetically aligned domains that are reversed as the transient magnetic field is swept at high frequency.

Accordingly, as shown in FIGS. 2 and 3, a printing nozzle 80 and tip 100 for use in fused deposition modeling includes a metallic material guide or barrel 85 for permitting a desired flow of material wherein the tip 100 is positioned at an end of the material guide, or barrel 85, for depositing the material in an appropriate position in space. The printing nozzle 80 may further include a plate 90 at an end of the barrel 85 around the tip 100. The barrel 85 may be constructed of aluminum or similar metallic material having the desired properties. Alternatively, the barrel 85 may comprise a ceramic or similar non-electrically conductive material that is transparent to electromagnetic energy. This alternative arrangement permits direct hearing of the working material from the coil 120.

FIG. 3 also shows an electro-magnetic heating element positioned with respect to the metallic barrel 85. According to a preferred embodiment of the invention, the electro-magnetic heating element comprises a coil 120 positioned around the barrel 85. As described above, a thermally conductive wrap 105 may be placed between the barrel 85 and the coil 120.

The coil 120 is preferably an induction heating coil wherein a desired number of turns of the coil 120 are used to introduce inductance into the nozzle 80 thereby producing a desired and controllable heating. Alternatively, a series of coils may be positioned around or with respect to the nozzle 80 to provide the desired heating. According to a preferred embodiment of this invention, the nozzle 80 is directly coupled to the power supply, i.e., the electro-magnetic energy source. The thermal link to the nozzle 80 may thus be quickly and controllably decoupled by decoupling the power supply from the nozzle 80. In this manner, heat control may be precisely administered to the nozzle 80.

According to one preferred embodiment, the electro-magnetic heating element, particularly the coil 120, is maintained at a lower temperature than material guide, or barrel 85. The printing nozzle 80 may further include a heat exchanger (not shown), primarily for cooling, positioned with respect to at least one of the tip 100 and the barrel 85 to provide a desired cooling to one or both respective components. In this manner, the deposition of material may be precisely controlled so as to avoid and excess or absence of material deposition in the desired locations. The heat exchanger may circulate at least one of helium and nitrogen to provide the desired cooling to the nozzle 80, more specifically to the tip 100 and/or the barrel 85 of the nozzle 80.

The nozzle 80 preferably produces a time varying, high flux, frequency sweeping, alternating magnetic field in the vicinity of the nozzle 80 so that (i) the time varying magnetic field penetrates into and is coupled by the magnetically susceptible working material to induce transient magnetic domains resulting in heating of the magnetically active components; and/or (ii) the transient magnetic field penetrates into and is coupled by the electrically conductive working material to generate an induced, annular current that causes direct electrical resistive heating of the material.

As described above, FIG. 3 shows a schematic of an electromagnetic apparatus according to one preferred embodiment of this invention. According to one embodiment, desired feed materials may be suspended in the apparatus within a coil, for example, water-cooled copper, and subjected to sinusoidal AC fields with a frequency of 180 kHz at several power settings. The feed material samples may be instrumented for surface and internal temperature measurements. The electromagnetic fields are then applied and the temperature was recorded as a function of time.

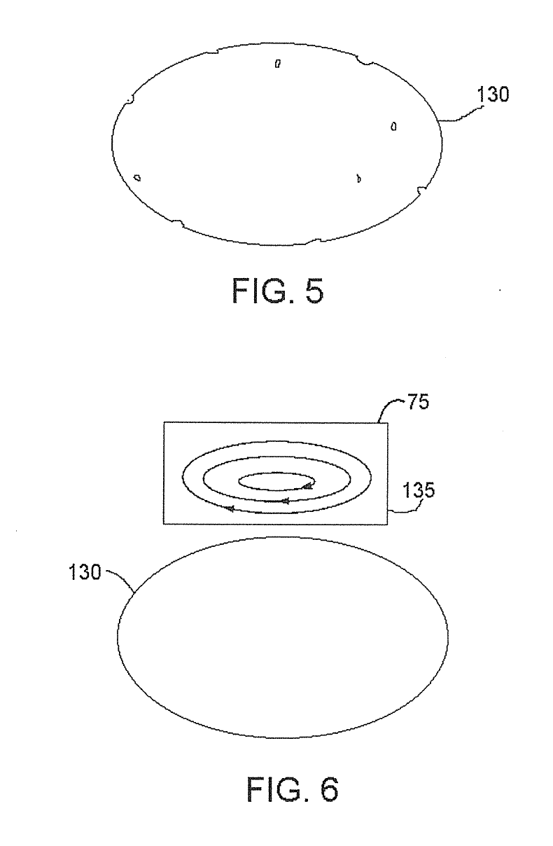

FIG. 5 shows a material bead 130 extruded through a suitable nozzle, such as nozzle 80 described above. The material bead 130 includes imperfections, such a small surface cracks, microvoids and/or air pockets. While these imperfections may not initially cause mechanical failure in the produced part, they can cause loss of structural integrity over time and/or when present through the many material beads within layers of the produced part. The methods and devices of this invention are applied to improve the structural integrity of the deposited working material bead 130.

In embodiments of this invention, imperfections are removed through a post-extrusion heating and/or application of a magnetic field. Referring to FIG. 1, the post-extrusion heating or magnetic field can be applied through one or more heat or electromagnetic field generators 75, which can be a conventional heater, an electromagnetic field generator and/or heating element, such as described above, and/or a magneto-dynamic heater. The generator 75 can be separate from of the extrusion deposition system, such as a manual or robotically controlled device that is moved over or about the deposited working material. Additionally or alternatively, the generator 75 can be integral or otherwise connected to the system, such as moveably connected to frame 50 to move over or about the working material on the deposition surface 55 and/or controlled by control system 70. The generator 75 can also be applied to the gantry arm 60 to trail the nozzle 80, thereby treating the material bead 130 immediately after extrusion and/or deposition.

In one embodiment of this invention, electro-magnetic constriction is used to remove any imperfections or voids during material deposition and/or after the part is produced. For constriction, the deposited working material is at least one of magnetically susceptible or electrically conductive, and a magnetic field is produced, such as by the electromagnetic field generator 75, in a suitable vicinity of the deposited working material. Referring to FIG. 6, to apply electro-magnetic constriction to the deposited working material, a time varying electro-magnetic field, and more preferably a time varying, high flux, frequency sweeping, alternating magnetic field, is applied to an area. As shown in, and described above for, FIG. 4, the field induces current in the deposited working material opposing the build-up (change) of the primary magnetic field. This current generates an induced magnetic field; a field that is opposite of the applied magnetic field. These opposing magnetic fields generate forces within the deposited working material, which can be used to compact an area within the extrusion deposition part in a controlled manner, thereby eliminate voids or other imperfections detrimental to parts performance, as represented in FIG. 6.

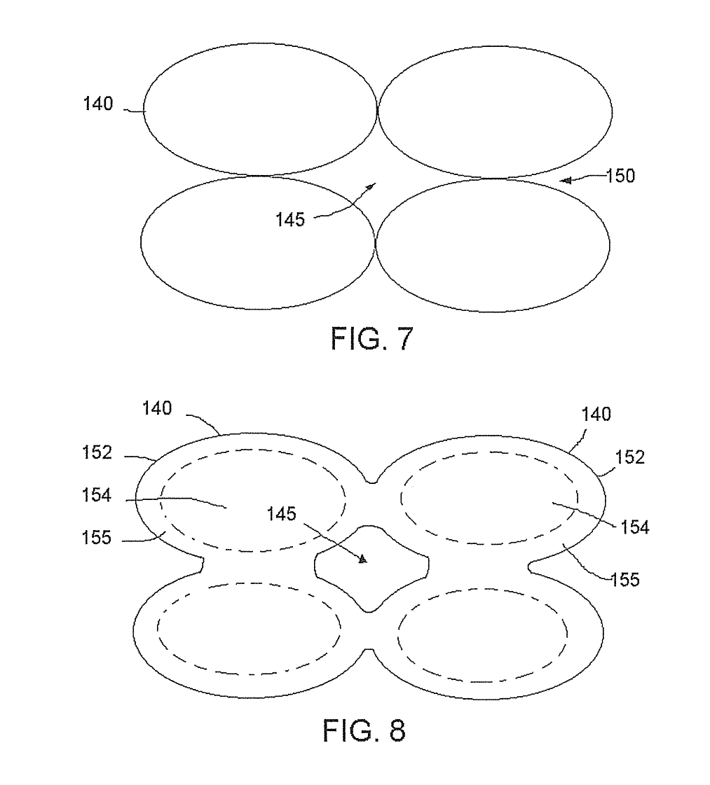

As representatively shown in FIG. 7, extrusion deposited working materials typically contain voids and/or air pockets between the adjacent material beads 140. These voids or air pockets 145 can have sharp stress concentrators 150 due to the material bead geometry, and can be detrimental to final mechanical properties or the produced part. In embodiments of this invention, electro-magnetic processing can be used to re-flow only a surface of the material bead(s), thereby blunting the sharp features without changing the overall geometry of the produced part.

FIG. 8 representatively shows a reflowing at, and just under, the surfaces 152 of the deposited material beads 140 that can be achieved via selective heating of the material surface by an electro-magnetic field using the “skin effect”. A time varying magnetic field is applied to the material to generate eddies near the material surface 152. Generating eddies in this manner cancels the current flow in the center 154 of the conductive material. The eddies heat the material to form a skin 155 near the surface 152 of the material beads 150. Tuning a surface reflow depth of the skin 155 of the working material can be performed by matching a magnetic response of the working material to an electromagnetic wave of the magnetic field. For example, the thickness of the skin δ can be estimated from

$$δ = \sqrt{\frac{2 ρ}{ω μ}} ,$$

where ρ is the material resistivity, ω is the frequency of the applied field and μ is the material permeability. It is apparent that the skin layer may be isolated best with conductive materials subjected to high frequency fields.

According to a preferred embodiment of this invention, heating efficiency and energy transfer dynamics are tunable in this magneto-dynamic approach by tailoring the magnetic and/or the conductive properties of the polymer feed material. This is accomplished by compounding the polymer feed stock with specific magnetically active materials, microscale particles, nano particles, and/or carbon fiber. As a result, a portfolio of tuned polymer feed materials may be employed depending on the desired characteristics of the build.

As described, the polymeric working material is preferably tuned by matching a magnetic response of the working material to an electromagnetic wave. This is preferably accomplished by compounding or doping the working material with magnetically active microscale and/or nano particles to adjust a heating efficiency of the magnetic field. The polymeric working material preferably comprises thermoplastic materials, such as nylon, ABS or Ultem™ resin, or a cross-linking thermoset, such as polyurethane or epoxy, all preferably in composite form. Application of this invention to thermosets with thermally activated crosslinking reactions, such as by generating a crosslinking temperature at or within the deposited working material, enables local control of reaction kinetics through the magneto-thermal conversion of the composite. The ability to spatially lock materials on demand enables an additional degree of control over the build. Suitable doping agents may include at least one of iron oxide, manganese borate, nano particles, and/or carbon fiber. Suitable nano particles may include at least one of Ho_{0.06}Fe_{2.94}O₄ and Gd_{0.06}Fe_{2.94}O₄.

According to a preferred embodiment of the invention, the polymeric working material comprises 90-99% epoxy and 1-10% doping agent and more preferably 95-99% epoxy and 1-5% doping agent.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A method of additive manufacturing comprising the steps of:
heating a polymeric working material;
depositing the polymeric working material to form a deposited working material; and
at least one of heating or applying a magnetic field to the deposited working material to improve structural integrity of the deposited working material.

2. The method of claim 1, further comprising:
reducing voids or air pockets in the deposited working material.

3. The method of claim 1, wherein the deposited working material comprises a deposited material bead or a partially or fully produced component.

4. The method of claim 1, further comprising:
extruding the polymeric working material through a deposition nozzle.

5. The method of claim 1, wherein the polymeric working material comprises a nylon composite.

6. The method of claim 1, wherein the polymeric working material comprises an epoxy doped with a doping agent including at least one of iron oxide, manganese borate, or nano particles.

7. The method of claim 1, further comprising:
compounding the working material with magnetically active microscale and nano particles to adjust a heating efficiency of the magnetic field.

8. The method of claim 1, wherein deposited working material is at least one of magnetically susceptible or electrically conductive, and further comprising:
producing the magnetic field in the vicinity of the deposited working material.

9. The method of claim 8, wherein at least one of the following processes occurs:
i. a time varying magnetic field penetrates into and is coupled by the magnetically susceptible working material to induce transient magnetic domains resulting in constriction or compaction of the deposited working material; or
ii. a transient magnetic field penetrates into and is coupled by the electrically conductive working material to generate an induced, annular current that causes direct electrical resistive heating and reflow of the deposited working material.

10. The method of claim 1, further comprising:
applying a time varying, high flux, frequency sweeping, alternating magnetic field to an area of the deposited working material.

11. The method of claim 10, further comprising:
generating an induced magnetic field within the deposited working material to compact an area of the deposited working material.

12. The method of claim 1, further comprising:
reflowing a surface of at least one material bead within the deposited working material.

13. The method of claim 7, further comprising:
generating eddies near the surface to cancel a current flow in a center of the material bead.

14. The method of claim 1, further comprising:
tuning a surface reflow depth of the working material by matching a magnetic response of the working material to an electromagnetic wave of the magnetic field.

15. The method of claim 1, wherein the polymeric working material comprises a thermoset polymer material and further comprising heating or applying a magnetic field to the deposited working material to crosslinking the deposited working material.

16. An apparatus for additive manufacturing, the apparatus comprising:
a nozzle for extruding a plastic material that is at least one of magnetically susceptible and electrically conductive;
a deposition surface disposed beneath the nozzle; and
a magneto-dynamic heater that produces a magnetic field at the deposition surface to penetrate into the working material to heat the material through at least one of an induced transient magnetic domain and an induced, annular current.

17. The apparatus of claim 16, wherein the magnetic field comprises a time varying, high flux, frequency sweeping, alternating magnetic field.

18. The apparatus of claim 16, wherein the polymeric working material is both magnetically susceptible and electrically conductive.

19. The apparatus of claim 16, wherein the magneto-dynamic heater comprises an adjustable electromagnetic field.

20. The apparatus of claim 16, wherein the magneto-dynamic heater comprises a controller that tunes a surface reflow depth of the working material by matching an electromagnetic wave to a magnetic response of the working material.
